(19) United States
(12) Patent Application Publication
(10) Pub. No.: US 2022/0092379 A1
(43) Pub. Date: Mar. 24, 2022

(54) SYSTEM AND METHOD FOR GENERATING SOCIAL INTERACTION PLATFORM FOR DIGITAL ENTITIES WITHIN EXTENDED REALITY ENVIRONMENTS

(71) Applicant: Dimension NXG Private Lilmited, Maharashtra (IN)

(72) Inventors: Pankaj RAUT, Maharashtra (IN); Abiijit PATIL, Maharashtra (IN); Abhishek TOMAR, Maharashtra (IN); Suraj Kumar Choudhardy, Maharashtra (IN)

(21) Appl. No.: 17/420,851

(22) PCT Filed: Jan. 10, 2020
(86) PCT No.: PCT/IB2020/050172

§ 371 Date: Jul. 6, 2021

(30) Foreign Application Priority Data
Jan. 10, 2019 (IN) 201921001089

(51) Int. Cl. G06N 3/00; G06F 3/01; G06N 20/00

(52) U.S. Cl. CPC G06N 3/006; G06N 20/00; G06F 3/011

(57) ABSTRACT

A method (200) for enabling an HMD based social interaction between users and AI bots, comprises registering (210) one or more users associated with respective one or more HMDs (1021 . . . 102n), receiving, storing and displaying (220) AI content including one or more AI bots trained in a plurality of specific skills, receiving (230) a request regarding provision of training and/or information related to one or more specific skills, providing (240) a list of one or more AI bots trained in the required one or more specific skills, receiving (250) a selection of an AI bot from the respective HMD, providing (260) an interactive session with the selected AI bot on the respective HMD in an extended reality space, receiving (270) a feedback based on an experience of the interactive session and improving (280) the proficiency of the AI bot in the one or more specific skills based on the feedback.

### FIELD OF THE INVENTION

Embodiment of the present invention relates to applications of extended reality technologies and more particularly to a method, a system and a computer system for enabling a Head Mounted Device (HMD) based social interaction between users and Artificial Intelligence (AI) bots within extended reality environments.

### BACKGROUND OF THE INVENTION

Being the most cognitive living-being on the planet, humans always have explored ways of interacting with people located all around the globe. Various modes of interaction presently available to humans are calling, messages/chats, video callings, conferencing, ending recorded audio or videos. All of these modes of interaction require human presence. Physical presence of the user is essential to take calls or record audio/videos. Additionally, within scenarios of teaching in educational institutes, training in armed forces, assistance of a skilled doctor in a highly crucial surgery/operation and many more circumstances, a person may either have to be physically present to perform tasks or record its presence through video conferencing/recording. So, in all the aforementioned modes a person can only do one task at a time and cater to a particular group of people who are engaged in a conversation incorporating visual feeds.

Existing solutions don't provide a platform where any human being can use his pre-generate extended reality clone/avatar capable of imitating their behavioural and physical traits using artificial intelligence. Further there is no such platform where skills and services of human beings can be made available in extended reality in a collaborative manner, eventually enabling them to see themselves as being omnipresent, capable of virtually doing multiple tasks like singing, teaching, delivering talks etc. at any specific instance of time within any social construct.

Therefore, there is a need for a method, a system and a computer system for enabling a Head Mounted Device (HMD) based social interaction between users and Artificial Intelligence (AI) bots within extended reality environments.

### OBJECT OF THE INVENTION

An object of the present invention is to provide a method for enabling a Head Mounted Device (HMD) based social interaction between users and Artificial Intelligence (AI) bots within extended reality environments.

Another object of the present invention is to provide a system for enabling a Head Mounted Device (HMD) based social interaction between users and Artificial Intelligence (AI) bots within extended reality environments.

Yet another object of the present invention is to provide a computer system for enabling a Head Mounted Device (HMD) based social interaction between users and Artificial Intelligence (AI) bots within extended reality environments.

Yet another object of the present invention is to provide a platform for enabling interaction between personalised digital manifestations/ avatars of humans who are alive or dead in extended reality over a social media platform.

Yet another object of the present invention is to leverage artificial intelligence to enable individuals to interact with multiple people at the same instant of time without being physically present at each location.

Yet another object of the present invention is to develop a common platform where individuals can load their pre-generated avatars capable of displaying their own behavioural and physical traits inside mixed reality space.

Yet another object of the present invention is to provide the end users, a platform for breaking the time-space barrier by ensuring that their digital manifestations of deceased/alive humans can be present and leveraged by N-number of users for visual-auditory and haptic interaction at same instant of time across different spaces around the globe.

### SUMMARY OF THE INVENTION

The present invention is described hereinafter by various embodiments. This invention may, however, be embodied in many different forms and should not be construed as limited to the embodiment set forth herein.

According to the first aspect of the present invention, there is provided a method for enabling a Head Mounted Device (HMD) based social interaction between users and Artificial Intelligence (AI) bots of alive and deceased humans within extended reality environments. The method comprises registering one or more users associated with respective one or more HMDs, the one or more users being one or more AI bot creators operating the respective HMDs (1021 . . . 1024) and the one or more interactors operating the respective HMDs (1026 . . . 1029), receiving, storing and displaying AI content including one or more AI bots trained in a plurality of specific skills, from the one or more AI bot creators using the respective one or more HMDs, receiving a request from an interactor of the one or more interactors regarding provision of training and/or information related to one or more specific skills of the plurality of specific skills, providing a list of one or more AI bots trained in the required one or more specific skills on the respective HMD in response to the request received, receiving a selection of an AI bot from the respective HMD, providing an interactive session with the selected AI bot to the interactor on the respective HMD in an extended reality space, for provision of training and/or the information related to the required one or more specific skills, receiving a feedback from the interactor based on an experience of the interactive session and improving the proficiency of the AI bot in the one or more specific skills and/or learning one or more new specific skills based on the feedback. Further, the one or more AI bots are digital manifestations and/or holographic projections of respective one or more deceased or alive humans accessible in the extended reality space, configured with the plurality of specific skills of the one or more respective deceased/alive humans.

In accordance with an embodiment of the present invention, the step of registration of the one or more users includes receiving details of a user of the one or more users, selected from group comprising a name, a date of birth, a location, an email address, a contact number, a preferred language and information of the user being an AI bot creator or the interactor or both and creating a user profile based on the received details.

In accordance with an embodiment of the present invention, the plurality of specific skills are selected from a group comprising academic skills, teaching skills, musical skills, domestic skills, communication skills and technical skills.

In accordance with an embodiment of the present invention, the interactive session includes the provision of training and/or information to the interactor by the selected AI bot through visual-auditory and haptic interaction involving question-answers, explanation, visual demonstrations and simulations of the desired one or more specific skills in the extended reality space.

In accordance with an embodiment of the present invention, the interactive session is facilitated in multiple languages with the multiple interactors for visual-auditory and haptic interaction at same instant of time across different spaces around the world.

In accordance with an embodiment of the present invention, the feedback includes specific suggestions for improvement by the one or more interactors, one or more unanswered questions beyond a skill level of the AI bot, most requested specific skills not pre-configured in the AI bot.

In accordance with an embodiment of the present invention, the AI bots of one or more deceased or alive humans include physical characteristics, behavioural characteristics and the specific skills of the respective deceased or alive human.

In accordance with an embodiment of the present invention, the one or more AI bot creators are enabled to tweak and improve the physical characteristics and the behavioural characteristics of respective AI bot.

In accordance with an embodiment of the present invention, the digital manifestation/telepresence of one or more alive humans is real-time podcast or telecast or is pre-recorded as a session.

According to the first aspect of the present invention, there is provided a computer system for enabling a Head Mounted Device (HMD) based social interaction between users and Artificial Intelligence (AI) bots of alive and deceased humans within Extended Reality (XR) environments, the computer system being connected with the XR based one or more HMDs associated with respective one or more users and a data repository. The computer system comprises a memory unit configured to store machine-readable instructions and a processor operably connected with the memory unit. The processor obtains the machine-readable instructions from the memory unit, and is configured by the machine-readable instructions to register the one or more users associated with the respective one or more HMDs, the one or more users being one or more AI bot creators operating the respective HMDs (1021 . . . 1024) and the one or more interactors operating the respective HMDs (1026 . . . 1029), receive, store and display AI content including one or more AI bots trained in a plurality of specific skills, from the one or more AI bot creators using the respective one or more HMDs, receive a request from an interactor of the one or more interactors regarding provision of training and/or information related to one or more specific skills of the plurality of specific skills, provide a list of one or more AI bots trained in the required one or more specific skills on the respective HMD in response to the request received, receive a selection of an AI bot from the respective HMD, provide an interactive session with the selected AI bot to the interactor on the respective HMD in an extended reality space, for provision of training and/or the information related to the required one or more specific skills, receive a feedback from the interactor based on an experience of the interactive session and improve the proficiency of the AI bot in the one or more specific skills and/or learning one or more new specific skills based on the feedback. Further, the one or more AI bots are digital manifestations and/or holographic projections of respective one or more deceased or alive humans accessible in the extended reality space, configured with the plurality of specific skills of the one or more respective deceased/alive humans.

In accordance with an embodiment of the present invention, for registration of the one or more users, the processor is configured to receive details of a user of the one or more users, selected from group comprising a name, a date of birth, a location, an email address, a contact number, a preferred language and information of the user being an AI bot creator or the interactor or both and create a user profile based on the received details.

In accordance with an embodiment of the present invention, the plurality of specific skills are selected from a group comprising academic skills, teaching skills, musical skills, domestic skills, communication skills and technical skills.

In accordance with an embodiment of the present invention, the interactive session includes the provision of training and/or information to the interactor by the selected AI bot through visual-auditory and haptic interaction involving question-answers, explanation, visual demonstrations and simulations of the desired one or more specific skills in the extended reality space.

In accordance with an embodiment of the present invention, the processor is configured to facilitate interactive session in multiple languages with the multiple interactors for visual-auditory and haptic interaction at same instant of time across different spaces around the world.

In accordance with an embodiment of the present invention, the feedback includes specific suggestions for improvement by the one or more interactors, one or more unanswered questions beyond a skill level of the AI bot, most requested specific skills not pre-configured in the AI bot.

In accordance with an embodiment of the present invention, the AI bots of one or more deceased or alive humans include physical characteristics, behavioural characteristics and the specific skills of the respective deceased or alive human.

In accordance with an embodiment of the present invention, the processor is configured to enable the one or more AI bot creators to tweak and improve the physical characteristics and the behavioural characteristics of respective AI bot.

In accordance with an embodiment of the present invention, the digital manifestation/telepresence of one or more alive humans is real-time podcast or telecast or is pre-recorded as a session.

According to a third aspect of the invention, there is provided a system for enabling a Head Mounted Device (HMD) based social interaction between users and Artificial Intelligence (AI) bots of alive and deceased humans within Extended Reality (XR) environments. The system comprises one or more HMDs, a registration module, an interface module, a control module, a feedback module and a data repository. Further, the registration module is configured to register one or more users associated with the respective one or more HMDs, the one or more users being one or more AI bot creators operating the respective HMDs (1021 . . . 1024) and the one or more interactors operating the respective HMDs (1026 . . . 1029). Furthermore, the interface module is configured to receive, store and display AI content including one or more AI bots trained in a plurality of specific skills, from the one or more AI bot creators using the respective one or more HMDs, receive a request from an interactor of the one or more interactors regarding provision of training and/or information related to one or more specific skills of the plurality of specific skills, provide a list of one or more AI bots trained in the required one or more specific skills on the respective HMD in response to the request received and receive a selection of an AI bot from the respective HMD. Additionally, the control module is configured to provide an interactive session with the selected AI bot to the interactor on the respective HMD in an extended reality space, for provision of training and/or the information related to the required one or more specific skills. Moreover, the feedback module is configured to receive a feedback from the interactor based on an experience of the interactive session and improve the proficiency of the AI bot in the one or more specific skills and/or learning one or more new specific skills based on the feedback.

In addition, the one or more AI bots are digital manifestations and/or holographic projections of respective one or more deceased or alive humans accessible in the extended reality space, configured with the plurality of specific skills of the one or more respective deceased/alive humans.

In accordance with an embodiment of the present invention, for registration of the one or more users, the registration module in combination with the interface module, is configured to receive details of a user of the one or more users, selected from group comprising a name, a date of birth, a location, an email address, a contact number, a preferred language and information of the user being an AI bot creator or the interactor or both and create a user profile based on the received details.

In accordance with an embodiment of the present invention, the plurality of specific skills are selected from a group comprising academic skills, teaching skills, musical skills, domestic skills, communication skills and technical skills.

In accordance with an embodiment of the present invention, the interactive session includes the provision of training and/or information to the interactor by the selected AI bot through visual-auditory and haptic interaction involving question-answers, explanation, visual demonstrations and simulations of the desired one or more specific skills in the extended reality space.

In accordance with an embodiment of the present invention, the control module is configured to facilitate interactive session in multiple languages with the multiple interactors for visual-auditory and haptic interaction at same instant of time across different spaces around the world.

In accordance with an embodiment of the present invention, the feedback includes specific suggestions for improvement by the one or more interactors, one or more unanswered questions beyond a skill level of the AI bot, most requested specific skills not pre-configured in the AI bot.

In accordance with an embodiment of the present invention, the AI bots of one or more deceased or alive humans include physical characteristics, behavioural characteristics and the specific skills of the respective deceased or alive human.

In accordance with an embodiment of the present invention, the control module is configured to enable the one or more AI bot creators to tweak and improve the physical characteristics and the behavioural characteristics of respective AI bot.

In accordance with an embodiment of the present invention, the digital manifestation/telepresence of one or more alive humans is real-time podcast or telecast or is pre-recorded as a session.

### BRIEF DESCRIPTION OF THE DRAWINGS

So that the manner in which the above recited features of the present invention can be understood in detail, a more particular to the description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, the invention may admit to other equally effective embodiments.

These and other features, benefits and advantages of the present invention will become apparent by reference to the following text figure, with like reference numbers referring to like structures across the views, wherein:

FIG. 1 illustrates an exemplary environment of computing devices to which the various embodiments described herein may be implemented, in accordance with an embodiment of the present invention;

FIG. 2 illustrates a method for enabling a Head Mounted Device (HMD) based social interaction between users and Artificial Intelligence (AI) bots within extended reality environments, in accordance with an embodiment of the present invention;

FIG. 3A illustrates an information flow diagram of receiving AI content including one or more AI bots, in accordance with an embodiment of the present invention;

FIG. 3B illustrates an information flow diagram of receiving a request for provision of training/information from the AI bots and selection of the desired AI bot, in accordance with an embodiment of the present invention;

FIG. 3C illustrates an information flow diagram of provision of a training session in an extended reality space, to an interactor using the respective HMD, in accordance with an embodiment of the present invention;

FIG. 3D illustrates an information flow diagram of receiving a feedback from the interactor and improvement of the AI bot providing the training based on the feedback, in accordance with an embodiment of the present invention; and

FIG. 4 illustrates a system for enabling a Head Mounted Device (HMD) based social interaction between users and Artificial Intelligence (AI) bots within extended reality environments, in accordance with an embodiment of the present invention.

### DETAILED DESCRIPTION OF DRAWINGS

While the present invention is described herein by way of example using embodiments and illustrative drawings, those skilled in the art will recognize that the invention is not limited to the embodiments of drawing or drawings described and are not intended to represent the scale of the various components. Further, some components that may form a part of the invention may not be illustrated in certain figures, for ease of illustration, and such omissions do not limit the embodiments outlined in any way. It should be understood that the drawings and detailed description thereto are not intended to limit the invention to the particular form disclosed, but on the contrary, the invention is to cover all modifications, equivalents, and alternatives falling within the scope of the present invention as defined by the appended claims. As used throughout this description, the word “may” is used in a permissive sense (i.e. meaning having the potential to), rather than the mandatory sense, (i.e. meaning must). Further, the words “a” or “an” mean “at least one” and the word “plurality” means “one or more” unless otherwise mentioned. Furthermore, the terminology and phraseology used herein is solely used for descriptive purposes and should not be construed as limiting in scope. Language such as “including,” “comprising,” “having,” “containing,” or “involving,” and variations thereof, is intended to be broad and encompass the subject matter listed thereafter, equivalents, and additional subject matter not recited, and is not intended to exclude other additives, components, integers or steps. Likewise, the term “comprising” is considered synonymous with the terms “including” or “containing” for applicable legal purposes. Any discussion of documents, acts, materials, devices, articles, and the like are included in the specification solely for the purpose of providing a context for the present invention. It is not suggested or represented that any or all of these matters form part of the prior art base or were common general knowledge in the field relevant to the present invention.

In this disclosure, whenever a composition or an element or a group of elements is preceded with the transitional phrase “comprising”, it is understood that we also contemplate the same composition, element or group of elements with transitional phrases “consisting of”, “consisting”, “selected from the group of consisting of, “including”, or “is” preceding the recitation of the composition, element or group of elements and vice versa.

The present invention is described hereinafter by various embodiments with reference to the accompanying drawings, wherein reference numerals used in the accompanying drawing correspond to the like elements throughout the description. This invention may, however, be embodied in many different forms and should not be construed as limited to the embodiment set forth herein. Rather, the embodiment is provided so that this disclosure will be thorough and complete and will fully convey the scope of the invention to those skilled in the art. In the following detailed description, numeric values and ranges are provided for various aspects of the implementations described. These values and ranges are to be treated as examples only and are not intended to limit the scope of the claims. In addition, a number of materials are identified as suitable for various facets of the implementations. These materials are to be treated as exemplary and are not intended to limit the scope of the invention.

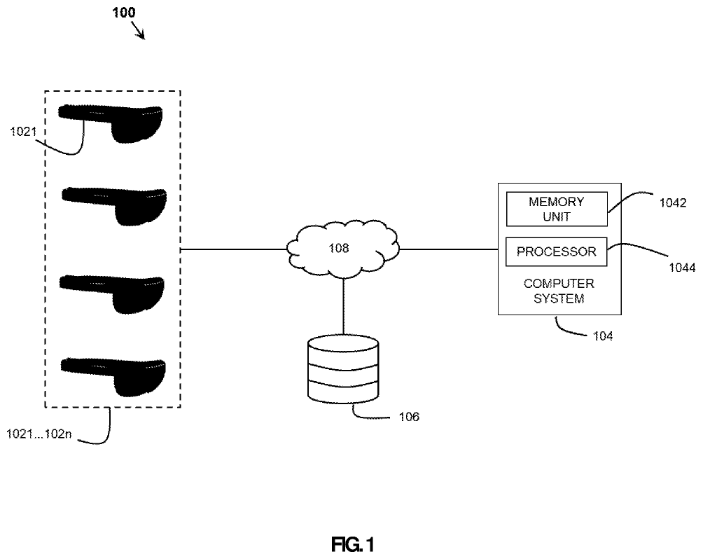

FIG. 1 illustrates an exemplary environment (100) of computing devices to which the various embodiments described herein may be implemented, in accordance with an embodiment of the present invention.

As shown in FIG. 1, the environment (100) comprises a computer system (104). The computer system (104) is comprises a memory unit (1042) configured to store machine-readable instructions. The machine-readable instructions may be loaded into the memory unit (1042) from a non-transitory machine-readable medium, such as, but not limited to, CD-ROMs, DVD-ROMs and Flash Drives. Alternately, the machine-readable instructions may be loaded in a form of a computer software program into the memory unit (1042). The memory unit (1042) in that manner may be selected from a group comprising EPROM, EEPROM and Flash memory. Further, the computer system (104) includes a processor (1044) operably connected with the memory unit (1042). In various embodiments, the processor (1044) is one of, but not limited to, a general-purpose processor, an application specific integrated circuit (ASIC) and a field-programmable gate array (FPGA). In accordance with an embodiment of the present invention, the processor (1044) is envisaged to include artificial intelligence and machine learning capabilities.

The computer system (104) is connected with the network (108). The network (108) may be one of, but not limited to, a Local Area Network (LAN) or a Wide Area Network (WAN). The network (108) may be implemented using a number of protocols, such as but not limited to, TCP/IP, 3GPP, 3GPP2, LTE, IEEE 802.x etc. Preferably, the network (108) is internet.

Further connected with the network (108), is a data repository (106). The data repository (106) may be maintained on a cloud-based storage or a local storage. In several embodiments, data repository (106) may be representative of several databases storing individual databases of AI content. The data repository (106) may also be a distributed database, distributed along several nodes providing peer to peer functionalities. In any manner, the data repository (106) is envisaged to be capable of providing the data to any of the computing devices connected with the network (108), when the data is queried appropriately using applicable security and other data transfer protocols.

Further, the network (108) is connected with one or more Head Mounted Devices (HMDs) (1021 . . . 102n). The one or more HMDs (1021 . . . 102n) may be envisaged to include capabilities of generating an augmented reality (AR) environment, mixed reality (MR) environment and an Extended Reality (XR) environment. Each of the one or more HMDs (1021 . . . 102n) is envisaged to include a number of components and sensors that enable the one or more HMDs (1021 . . . 102n) to work.

These components and sensors may be used to gather and track spatial data of the real-world environment as well as to track eye movement and hand gesture of a user so as to update the 3D generated objects in XR and MR. The sensors may include, but not limited to, an IR projector, one or more cameras, an RGB sensors & a depth sensor. Additionally, there may be one or more speakers and a microphone array. RGB sensors captures coloured imagery of the real-world environment. Each of the one or more HMDs (1021 . . . 102n) is capable of capturing depth data of the real-world environment using any one or more of Time of Flight based and passive stereoscopic depth imaging.

The microphone array is envisaged to receive and record audio. There may be a voice identification module & a facial and body posture identification module inside each of the one or more HMDs (1021 . . . 102n). The voice identification module may enable capabilities to mimic a particular human's sound by listening for some duration of time. The facial and body posture identification module may use state of the art 6-DOF Human Body Pose estimation and facial expression detection technologies to estimate body posture and facial expressions.

Furthermore, each of the one or more HMDs (1021 . . . 102n) may have a user interface such as, but not limited to, one or more buttons, a gesture interface, a knob, an audio interface, and a touch-based interface, and the like. The interaction with the plurality of computing devices and other connected components may be, performed through pressing the button, hovering the hand and/or other body parts, providing audio input and/or tactile input through one or more fingers.

Moreover, each of the one or more HMDs (1021 . . . 102n) may further comprise visors of may be partially or fully reflective surface. In other words, the visors may have a variable transparency. The visors are used to view human or object in extended reality, mixed reality or augmented reality. Each of the one or more HMDs (1021 . . . 102n) may further include cooling vent to ensure that internal circuitry and devices of the one or more HMDs (1021 . . . 102n) are provided with enough amount of air for convection cooling. A wire outlet may also be provided to allow the connecting wires and chords to connect to various components such as power supply, computational and control units and data acquisition devices.

Further, each of the one or more HMDs (1021 . . . 102n) is envisaged to include extendable bands and straps and a strap lock for securing the respective HMD positioned on a head of a user of the one or more users. Each of the one or more HMDs (1021 . . . 102n) is envisaged to include one or more display such as, but not limited to, an LCoS (Liquid Crystal on Silicon) display with respective drivers. Each of the one or more HMDs (1021 . . . 102n) may also include a driver board including a part of computational software and hardware needed to run devices provided with the respective HMD. Moreover, each of the one or more HMDs (1021 . . . 102n) may include, HDMI output to allow data to be transferred. A Universal serial bus (USB) connector to allow data and power transfer. Also, each of the one or more HMDs (1021 . . . 102n) may also to include a plurality of electronic components, for example, a graphics processor unit (GPU) and a power source provide electrical power to the HMD (102) which may be externally connected or may be internally provided.

A Graphics Processing Unit (GPU) is a single-chip processor primarily used to manage and boost the performance of video and graphics such as 2-D or 3-D graphics, texture mapping, hardware overlays etc. The GPU may be selected from, but not limited to, NVIDIA, AMD, Intel and ARM for real time 3D imaging. The power source may be inbuilt inside the HMD. A plurality of indicators such as LED to indicate various parameters such as battery level or connection disconnection may be included in the HMD. The indications may be colour coded for differentiation and distinctiveness. In that sense, the one or more HMDs (1021 . . . 102n) may be, but not limited to, XR based headsets or smart glasses.

The one or more HMDs (1021 . . . 102n) are associated with/operated by one or more users who either create Artificial Intelligence (AI) content, hereinafter referred to as “the AI bot creators” or access/interact with the AI content hereinafter referred to as “one or more interactors”. For the explanation purpose, the one or more AI bot creators are envisaged to be associated with respective HMDs (1021 . . . 1024) and the one or more interactors are envisaged be associated with respective HMDs (1026 . . . 1029). In accordance with an embodiment of the present invention, a user of the one or more users may be an AI bot creator as well as an interactor.

Additionally, the AI content may include one or more AI bots. The one or more AI bots may be understood as digital manifestations and/or holographic projections of respective one or more deceased or alive humans. In accordance with an embodiment of the present invention, the digital manifestation/telepresence of one or more alive humans as AI bots, may be a real-time podcast or telecast or may pre-recorded as a session. The one or more AI bots of the one or more deceased or alive humans may include physical characteristics, behavioural characteristics of the respective deceased or alive human. The one or more behavioural characteristics may comprise a thought process, reactions in predetermined situations and mannerisms including a way of walking, sitting, sprinting, eating, interaction with people, performance of daily chores and daily life objects. The one or more physical characteristics including an appearance and vocals of the human. For example: an AI bot may be of a deceased personality like Michael Jackson or any living personality, such as the AI bot creator himself/herself. The AI bot may look, walk, talk, behave etc. like the Michael Jackson or the AI bot creator himself, depending upon whose bot has been generated.

Further, the one or more AI bots may be configured with the plurality of specific skills of the respective one or more deceased/alive humans whose AI bot has been generated. The plurality of specific skills are selected from a group comprising academic skills, teaching skills, musical skills, domestic skills, communication skills and technical skills. These may include, but not limited to, educational background, thought process, singing, dancing, knowledge of musical instruments, cooking, painting, public speaking and scientific knowledge of the human whose bot has been generated. For example: the AI bot of Michael Jackson would be configured with the singing and dancing skills of Michael Jackson as well. Or if the AI bot is of the AI bot creator himself/herself and the AI bot creator is an architect, then the generated AI bot would be envisaged to be trained in architecture apart from appearing and speaking like the AI bot creator. Furthermore, the one or more AI bots may only be accessible in the extended reality space generated by the respective XR-based one or more HMDs (1021 . . . 102n).

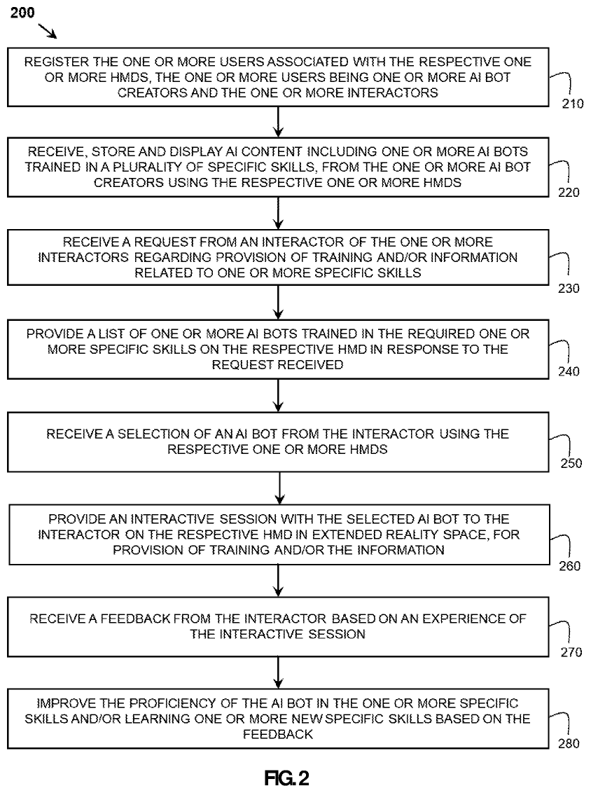

FIG. 2 is a method (200) enabling a Head Mounted Device (HMD) based social interaction between users and Artificial Intelligence (AI) bots of alive and deceased humans within extended reality environments, in accordance with an embodiment of the present invention. The method (200) begins at step 210, when the processor (1044) registers one or more users associated with respective one or more HMDs (1021 . . . 102n). For registration, the processor (1044) may receive respective details of each of the one or more users, selected from group comprising, but not limited to, a name, a date of birth, a location, an email address, a contact number, a preferred language and information of the user being an AI bot creator or the interactor or both. All the information may be provided using the respective one or more HMDs (1021 . . . 102n). In one embodiment, the processor (1044) may enable the one or more users to provide a preferred username and password for secure access. Accordingly, a user profile may be created based on the received details and a secure access may be provided to the respective one or more users.

As previously explained, the one or more users may be one or more AI bot creators associated with respective HMDs (1021 . . . 1024) and the one or more interactors associated with the respective HMDs (1026 . . . 1029). Also, any of the one or more users may have two user profiles under one registration, one being of “the AI bot creator” and the other being of “the interactor”.

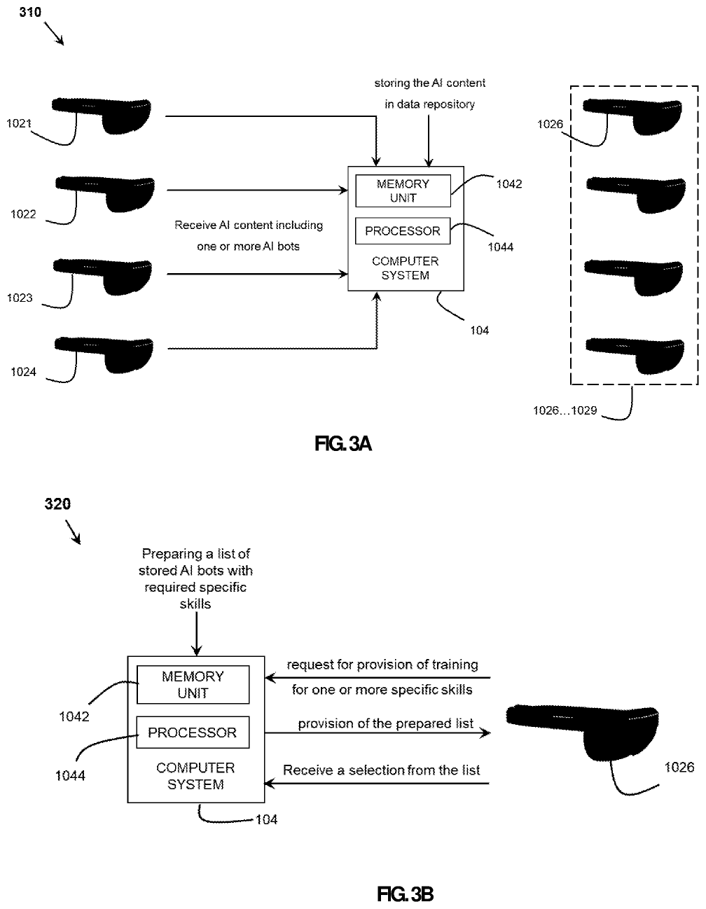

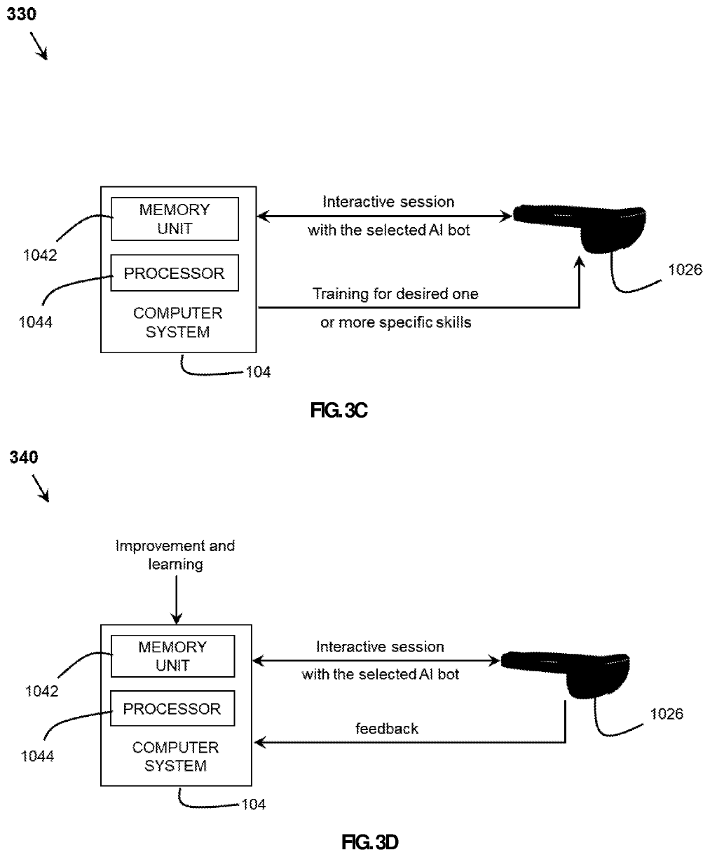

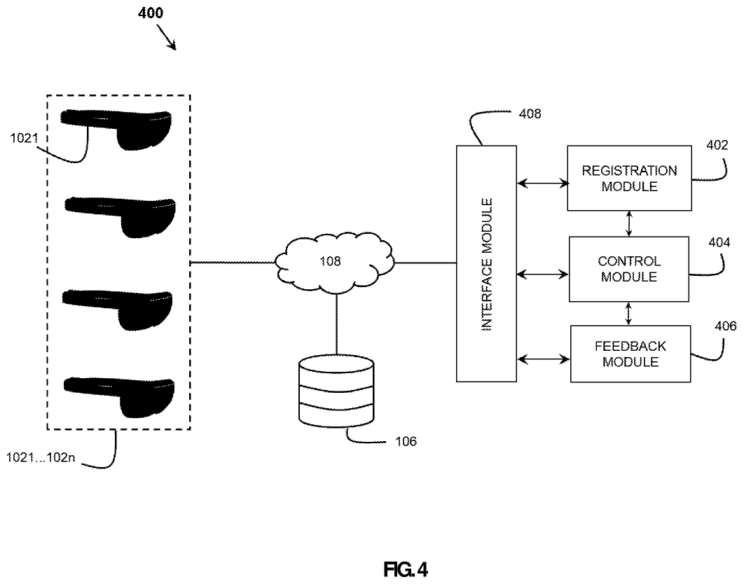

Then, at step 220, the AI content including the one or more AI bots trained in a plurality of specific skills, is received by the processor (1044) from the one or more AI bot creators using the respective one or more HMDs (1021 . . . 1024). The AI content is then stored in the data repository (106). The same has been illustrated in FIG. 3A. The received and stored AI content is hosted by the computer system (104). As previously explained, the one or more AI bots may be understood as digital manifestations and/or holographic projections of respective one or more deceased or alive humans such as, but not limited to, Michael Jackson, Jimi Hendrix, Mahatma Gandhi, Rabindranath Tagore, Amitabh Bachchan, Sachin Tendulkar or any other human, including the AI bot creator himself/herself. The one or more AI bots are envisaged to include the physical characteristics, behavioural characteristics and the specific skills of the respective deceased or alive human.

The AI content may be displayed by the computer system (104) for the one or more AI bot creators at the respective one or more HMDs (1021 . . . 1024) for confirmation of submission and/or further modification. In accordance with an embodiment of the present invention, processor (1044) also enables the one or more AI bot creators to tweak and improve the physical characteristics and the behavioural characteristics of respective AI bot using the respective HMDs (1021 . . . 1024). The one or more AI bot creators can modify their age, weights, skin tone, public speaking skills, language of conversation with end users etc. For example: the AI bot creator provides the generated AI bot of himself to the computer system (104) but isn't satisfied with the one or more of the physical characteristics such as a hairstyle and/or a way of speaking. Then, the processor (1044) enables the AI bot creator using the respective HMD (1021) to tweak and improve his hairstyle and/or way of speaking.

After that, at step 230, the processor (1044) receives a request from an interactor (using the HMD (1026)) of the one or more interactors operating the respective HMDs (1026 . . . 1029) regarding provision of training and/or information related to one or more specific skills of the plurality of specific skills. For example: the request is received for getting dancing lessons on hip-hop dance. Now, the processor (1044) would search the data repository (106) for prestored AI bots, provided by the one or more AI bot creators, who are trained in Hip-Hop dance form and are capable of training the interactor. The processor (1044) prepares a list of such one or more AI bots matching the requirements, based on the search.

Next, at step 240, the processor (1044) provides the list of one or more AI bots trained in the required one or more specific skills on the respective HMD (1026) of the interactor, in response to the request received. Now, the interactor goes through the list using the respective HMD (1026) and at step 250, the processor (1044) receives a selection of an AI bot from the interactor using the respective HMD (1026). The same has been illustrated in FIG. 3B.

Further, after the AI bot is selected, at step 260, the processor (1044) is configured to provide an interactive session with the selected AI bot to the interactor on the respective HMD (1026) in an extended reality space. In the interactive session, the AI bot provides training and/or the information related to the required one or more specific skills (like in previous example, required skill was hip-hop dance). The same has been illustrated in FIG. 3C. The training and/or information may be provided through visual-auditory and haptic interactions. This may include, but not limited to, question-answers, explanation, visual demonstrations and simulations of the desired one or more specific skills in the extended reality space. For example: the AI bot may show the dance steps himself/herself and/or may explain the step by step guide to perform those steps and/or show videos of popular dancers from the internet during the interactive session.

This is advantageous because it is very similar to physically training one-to-one with a tutor at any time and any place. Moreover, the interactive session may be facilitated in multiple languages with the multiple interactors for visual-auditory and haptic interaction at same instant of time across different spaces around the world. The language may be selected by the interactor as per the requirements. For example: the same AI bot may be providing cooking lesson to two different interactors at the same time in two different languages in their respective HMDs (1026 . . . 1029).

Further at step 270, the processor (1044) receives a feedback from the interactor using the respective HMD (1026) based on an experience of the interactive session. The feedback herein is meant to include, but not limited to, specific suggestions for improvement by the one or more interactors (after multiple interactive sessions), one or more unanswered questions beyond a skill level of the AI bot and most requested specific skills not pre-configured in the AI bot. For example: the interactor may specifically suggest the AI bot providing cooking lessons to improve the cooking skills, based on his experience. In another example, the interactor may ask the AI bot teaching guitar strumming to teach percussive guitar strumming, which is beyond the skill level of the AI bot. In this case, there is no specific suggestion, but this will be taken as a feedback for the AI bot as an unanswered question.

In yet another example, the AI bot trained in AutoCAD software is only being used for teaching 2D product designing and the one or more interactors switch to Solidworks when it comes to 3D product designing. In this case also, such action would be considered as the feedback for the AI bot as the “3D designing on Solidworks” was not a pre-configured skill of the AI bot but it is frequently being used.

After that, at step 280, the processor (1044) enables the AI bot creator to improve the proficiency of the AI bot in the one or more specific skills and/or learn one or more new specific skills based on the feedback received. The same has been illustrated in FIG. 3D. Continuing from the above mentioned examples, the respective AI bot creators based on the feedback received may further train and improve the respective AI bots to have better cooking skills or in second example, learn percussive strumming on guitar or in third example, learn 3D product designing in Solidworks. This is advantageous not just for the enrichment of the AI bot but also for the AI bot creator as he/she may learn what kind of training and skills are more in demand and beneficial for personal learning.

According to another aspect of the invention, there is provided a system (400) for enabling a Head Mounted Device (HMD) based social interaction between users and Artificial Intelligence (AI) bots of alive and deceased humans within Extended Reality (XR) environments, illustrated in FIG. 4. As shown in FIG. 4, the system (400) comprises one or more HMDs, a registration module (402), an interface module (408), a control module (404), a feedback module (406) and a data repository (106). Further, the registration module (402) is configured to register one or more users associated with the respective one or more HMDs (1021 . . . 102n), the one or more users being one or more AI bot creators operating the respective HMDs (1021 . . . 1024) and the one or more interactors operating the respective HMDs (1026 . . . 1029). Furthermore, the interface module (408) is configured to receive, store and display AI content including one or more AI bots trained in a plurality of specific skills, from the one or more AI bot creators using the respective HMDs (1021 . . . 1024); receive a request from an interactor of the one or more interactors operating the respective HMDs (1026 . . . 1029), regarding provision of training and/or information related to one or more specific skills of the plurality of specific skills; provide a list of one or more AI bots trained in the required one or more specific skills on the respective HMD (1026) in response to the request received; and receive a selection of an AI bot from the respective HMD (1026). Additionally, the control module (404) is configured to provide an interactive session with the selected AI bot to the interactor on the respective HMD (1026) in an extended reality space, for provision of training and/or the information related to the required one or more specific skills. Moreover, the feedback module (406) is configured to receive a feedback from the interactor based on an experience of the interactive session and improve the proficiency of the AI bot in the one or more specific skills and/or learning one or more new specific skills based on the feedback.

In addition, the one or more AI bots are digital manifestations and/or holographic projections of respective one or more deceased or alive humans accessible in the extended reality space, configured with the plurality of specific skills of the one or more respective deceased/alive humans.

In accordance with an embodiment of the present invention, for registration of the one or more users, the registration module (402) in combination with the interface module (408), is configured to receive respective details of each of the one or more users, selected from group comprising a name, a date of birth, a location, an email address, a contact number, a preferred language and information of the user being an AI bot creator or the interactor or both and create a user profile based on the received details.

In accordance with an embodiment of the present invention, the plurality of specific skills are selected from a group comprising academic skills, teaching skills, musical skills, domestic skills, communication skills and technical skills.

In accordance with an embodiment of the present invention, the interactive session includes the provision of training and/or information to the interactor by the selected AI bot through visual-auditory and haptic interaction involving question-answers, explanation, visual demonstrations and simulations of the desired one or more specific skills in the extended reality space.

In accordance with an embodiment of the present invention, the control module (404) is configured to facilitate interactive session in multiple languages with the multiple interactors for visual-auditory and haptic interaction at same instant of time across different spaces around the world.

In accordance with an embodiment of the present invention, the feedback includes specific suggestions for improvement by the one or more interactors, one or more unanswered questions beyond a skill level of the AI bot, most requested specific skills not pre-configured in the AI bot.

In accordance with an embodiment of the present invention, the AI bots of one or more deceased or alive humans include physical characteristics, behavioural characteristics and the specific skills of the respective deceased or alive human.

In accordance with an embodiment of the present invention, the control module (404) is configured to enable the one or more AI bot creators to tweak and improve the physical characteristics and the behavioural characteristics of respective AI bot using the respective HMDs (1021 . . . 1024).

In accordance with an embodiment of the present invention, the digital manifestation/telepresence of one or more alive humans is real-time podcast or telecast or is pre-recorded as a session.

Modules, as used herein, refers to logic embodied in hardware or firmware, or to a collection of software instructions, written in a programming language, such as, for example, Java, C, or assembly. One or more software instructions in the modules may be embedded in firmware, such as an EPROM. It will be appreciated that modules may comprised connected logic units, such as gates and flip-flops, and may comprise programmable units, such as programmable gate arrays or processors. The modules described herein may be implemented as either software and/or hardware modules and may be stored in any type of computer-readable medium or other computer storage device.

Further, while one or more operations have been described as being performed by or otherwise related to certain modules, devices or entities, the operations may be performed by or otherwise related to any module, device or entity. As such, any function or operation that has been described as being performed by a module could alternatively be performed by a different server, by the cloud computing platform, or a combination thereof. It should be understood that the techniques of the present disclosure might be implemented using a variety of technologies. For example, the methods described herein may be implemented by a series of computer executable instructions residing on a suitable computer readable medium. Suitable computer readable media may include volatile (e.g. RAM) and/or non-volatile (e.g. ROM, disk) memory, carrier waves and transmission media. Exemplary carrier waves may take the form of electrical, electromagnetic or optical signals conveying digital data steams along a local network or a publicly accessible network such as the Internet.

The computer system (104), the method (200) and the system (400) disclosed in the present invention implement a lot of data privacy, data ownership and data censorship clauses and methods in which all the new censored data collected by the AI bot while interacting with multiple users and the capabilities learnt from these interactions is the ownership of the AI bot creator.

The present invention offers a number of advantages. Firstly, the proposed invention can be sought as a cognitive, realistic and proactive substitute for the most popular social media platforms meant for interaction by sharing videos. The present invention aims to host pre-generated intelligent avatars capable of imitating the behavioural and physical characteristic of the living beings (alive or deceased). Existence of such an invention in the extended reality ensures that people can interact with multiple people at the same instant of time without being physically present at each location. This type of technology will be especially useful in scenarios where a skilled person is in great demand armed forces, education institutes, medical hospitals and civil engineering, to showcase his/her skills to the world at multiple places. Such a technology derived from the present invention can bloom many industries such as entertainment, hardware maintenance defence, education etc. The interaction of human beings with these avatars is possible through multiple modalities which include hand gestures, voice etc.

It should also be understood that, unless specifically stated otherwise as apparent from the following discussion, it is appreciated that throughout the description, discussions utilizing terms such as “controlling” or “obtaining” or “computing” or “storing” or “receiving” or “determining” or the like, refer to the action and processes of a computer system, or similar electronic computing device, that processes and transforms data represented as physical (electronic) quantities within the computer system's registers and memories into other data similarly represented as physical quantities within the computer system memories or registers or other such information storage, transmission or display devices.

Various modifications to these embodiments are apparent to those skilled in the art from the description and the accompanying drawings. The principles associated with the various embodiments described herein may be applied to other embodiments. Therefore, the description is not intended to be limited to the embodiments shown along with the accompanying drawings but is to be providing broadest scope of consistent with the principles and the novel and inventive features disclosed or suggested herein. Accordingly, the invention is anticipated to hold on to all other such alternatives, modifications, and variations that fall within the scope of the present invention and the appended claims.

1. A method (200) for enabling a Head Mounted Device (HMD) based social interaction between users and Artificial Intelligence (AI) bots of alive and deceased humans within extended reality environments, the method (200) comprising:
registering one or more users associated with respective one or more HMDs (1021 . . . 102n), the one or more users being one or more AI bot creators operating the respective HMDs (1021 . . . 1024) and the one or more interactors operating the respective HMDs (1026 . . . 1029);
receiving, storing and displaying AI content including one or more AI bots trained in a plurality of specific skills, from the one or more AI bot creators using the respective HMDs (1021 . . . 1024);
receiving a request from an interactor of the one or more interactors operating the respective HMDs (1026 . . . 1029), regarding provision of training and/or information related to one or more specific skills of the plurality of specific skills;
providing a list of one or more AI bots trained in the required one or more specific skills on the respective HMD (1026) in response to the request received;
receiving a selection of an AI bot from the respective HMD (1026) of the interactor;
providing an interactive session with the selected AI bot to the interactor on the respective HMD (1026) in an extended reality space, for provision of training and/or the information related to the required one or more specific skills;
receiving a feedback from the interactor based on an experience of the interactive session; and
improving the proficiency of the AI bot in the one or more specific skills and/or learning one or more new specific skills based on the feedback;
wherein the one or more AI bots are digital manifestations and/or holographic projections of respective one or more deceased or alive humans accessible in the extended reality space, configured with the plurality of specific skills of the one or more respective deceased/alive humans.

2. The method (200) as claimed in claim 1, wherein the step of registration of the one or more users includes:
receiving respective details of each of the one or more users, selected from group comprising a name, a date of birth, a location, an email address, a contact number, a preferred language and information of the user being an AI bot creator or the interactor or both; and
creating a user profile based on the received details.

3. The method (200) as claimed in claim 1, wherein the plurality of specific skills are selected from a group comprising academic skills, teaching skills, musical skills, domestic skills, communication skills and technical skills.

4. The method (200) as claimed in claim 1, wherein the interactive session includes the provision of training and/or information to the interactor by the selected AI bot through visual-auditory and haptic interaction involving question-answers, explanation, visual demonstrations and simulations of the desired one or more specific skills in the extended reality space.

5. The method (200) as claimed in claim 1, wherein the interactive session is facilitated in multiple languages with the multiple interactors for visual-auditory and haptic interaction at same instant of time across different spaces around the world.

6. The method (200) as claimed in claim 1, wherein the feedback includes specific suggestions for improvement by the one or more interactors, one or more unanswered questions beyond a skill level of the AI bot, most requested specific skills not pre-configured in the AI bot.

7. The method (200) as claimed in claim 1, wherein the AI bots of one or more deceased or alive humans include physical characteristics, behavioural characteristics and the specific skills of the respective deceased or alive human.

8. The method (200) as claimed in claim 7, wherein the one or more AI bot creators are enabled to tweak and improve the physical characteristics and the behavioural characteristics of respective AI bot using the respective HMDs (1021 . . . 1024).

9. The method (200) as claimed in 1, wherein the digital manifestation/telepresence of one or more alive humans is real-time podcast or telecast or is pre-recorded as a session.

10. A computer system (104) for enabling a Head Mounted Device (HMD) based social interaction between users and Artificial Intelligence (AI) bots of alive and deceased humans within Extended Reality (XR) environments, the computer system (104) being connected with the XR based one or more HMDs (1021 . . . 102n) associated with respective one or more users and a data repository (106), the computer system (104) comprising:
a memory unit (1042) configured to store machine-readable instructions; and
a processor (1044) operably connected with the memory unit (1042), the processor (1044) obtaining the machine-readable instructions from the memory unit (1042), and being configured by the machine-readable instructions to:
register the one or more users associated with the respective one or more HMDs (1021 . . . 102n), the one or more users being one or more AI bot creators operating the respective HMDs (1021 . . . 1024) and the one or more interactors operating the respective HMDs (1026 . . . 1029);
receive, store and display AI content including one or more AI bots trained in a plurality of specific skills, from the one or more AI bot creators using the respective HMDs (1021 . . . 1024);
receive a request from an interactor of the one or more interactors operating the respective HMDs (1026 . . . 1029), regarding provision of training and/or information related to one or more specific skills of the plurality of specific skills;
provide a list of one or more AI bots trained in the required one or more specific skills on the respective HMD (1026) in response to the request received;
receive a selection of an AI bot from the respective HMD (1026) of the interactor;
provide an interactive session with the selected AI bot to the interactor on the respective HMD (1026) in an extended reality space, for provision of training and/or the information related to the required one or more specific skills;
receive a feedback from the interactor based on an experience of the interactive session; and
improve the proficiency of the AI bot in the one or more specific skills and/or learning one or more new specific skills based on the feedback;
wherein the one or more AI bots are digital manifestations and/or holographic projections of respective one or more deceased or alive humans accessible in the extended reality space, configured with the plurality of specific skills of the one or more respective deceased/alive humans.

11. The computer system (104) as claimed in claim 10, wherein for registration of the one or more users, the processor (1044) is configured to:
receive respective details of each of the one or more users, selected from group comprising a name, a date of birth, a location, an email address, a contact number, a preferred language and information of the user being an AI bot creator or the interactor or both; and
create a user profile based on the received details.

12. The computer system (104) as claimed in claim 10, wherein the plurality of specific skills are selected from a group comprising academic skills, teaching skills, musical skills, domestic skills, communication skills and technical skills.

13. The computer system (104) as claimed in claim 10, wherein the interactive session includes the provision of training and/or information to the interactor by the selected AI bot through visual-auditory and haptic interaction involving question-answers, explanation, visual demonstrations and simulations of the desired one or more specific skills in the extended reality space.

14. The computer system (104) as claimed in claim 10, wherein the processor (1044) is configured to facilitate interactive session in multiple languages with the multiple interactors for visual-auditory and haptic interaction at same instant of time across different spaces around the world.

15. The computer system (104) as claimed in claim 10, wherein the feedback includes specific suggestions for improvement by the one or more interactors, one or more unanswered questions beyond a skill level of the AI bot, most requested specific skills not pre-configured in the AI bot.

16. The computer system (104) as claimed in claim 10, wherein the AI bots of one or more deceased or alive humans include physical characteristics, behavioural characteristics and the specific skills of the respective deceased or alive human.

17. The computer system (104) as claimed in claim 16, wherein the processor (1044) is configured to enable the one or more AI bot creators to tweak and improve the physical characteristics and the behavioural characteristics of respective AI bot using the respective HMDs (1021 . . . 1024).

18. The computer system (104) as claimed in claim 10, wherein the digital manifestation/telepresence of one or more alive humans is real-time podcast or telecast or is pre-recorded as a session.

19. A system (400) for enabling a Head Mounted Device (HMD) based social interaction between users and Artificial Intelligence (AI) bots of alive and deceased humans within Extended Reality (XR) environments, the system (400) comprising:
one or more HMDs (1021 . . . 102n);
a registration module (402);
an interface module (408);
a control module (404);
a feedback module (406); and
a data repository (106);
wherein the registration module (402) is configured to register one or more users associated with the respective one or more HMDs (1021 . . . 102n), the one or more users being one or more AI bot creators operating the respective HMDs (1021 . . . 1024) and the one or more interactors operating the respective HMDs (1026 . . . 1029);
wherein the interface module (408) is configured to:
receive, store and display AI content including one or more AI bots trained in a plurality of specific skills, from the one or more AI bot creators using the respective HMDs (1021 . . . 1024);
receive a request from an interactor of the one or more interactors operating the respective HMDs (1026 . . . 1029) regarding provision of training and/or information related to one or more specific skills of the plurality of specific skills;
provide a list of one or more AI bots trained in the required one or more specific skills on the respective HMD (1026) in response to the request received;
receive a selection of an AI bot from the respective HMD (1026) of the interactor;
wherein the control module (404) is configured to provide an interactive session with the selected AI bot to the interactor on the respective HMD (1026) in an extended reality space, for provision of training and/or the information related to the required one or more specific skills;
wherein the feedback module (406) is configured to:
receive a feedback from the interactor based on an experience of the interactive session; and
improve the proficiency of the AI bot in the one or more specific skills and/or learning one or more new specific skills based on the feedback;
wherein the one or more AI bots are digital manifestations and/or holographic projections of respective one or more deceased or alive humans accessible in the extended reality space, configured with the plurality of specific skills of the one or more respective deceased/alive humans.

20. The system (400) as claimed in claim 19, wherein for registration of the one or more users, the registration module (402) in combination with the interface module (408), is configured to:
receive respective details of each of the one or more users, selected from group comprising a name, a date of birth, a location, an email address, a contact number, a preferred language and information of the user being an AI bot creator or the interactor or both; and
create a user profile based on the received details.

21. The system (400) as claimed in claim 19, wherein the plurality of specific skills are selected from a group comprising academic skills, teaching skills, musical skills, domestic skills, communication skills and technical skills.

22. The system (400) as claimed in claim 19, wherein the interactive session includes the provision of training and/or information to the interactor by the selected AI bot through visual-auditory and haptic interaction involving question-answers, explanation, visual demonstrations and simulations of the desired one or more specific skills in the extended reality space.

23. The system (400) as claimed in claim 19, wherein the control module (404) is configured to facilitate interactive session in multiple languages with the multiple interactors for visual-auditory and haptic interaction at same instant of time across different spaces around the world.

24. The system (400) as claimed in claim 19, wherein the feedback includes specific suggestions for improvement by the one or more interactors, one or more unanswered questions beyond a skill level of the AI bot, most requested specific skills not pre-configured in the AI bot.

25. The system (400) as claimed in claim 19, wherein the AI bots of one or more deceased or alive humans include physical characteristics, behavioural characteristics and the specific skills of the respective deceased or alive human using the respective HMDs (1021 . . . 1024).

26. The system (400) as claimed in claim 15, wherein the control module (404) is configured to enable the one or more AI bot creators to tweak and improve the physical characteristics and the behavioural characteristics of respective AI bot.

27. The system (400) as claimed in claim 19, wherein the digital manifestation/telepresence of one or more alive humans is real-time podcast or telecast or is pre-recorded as a session.
